(19) United States
(12) Patent Application Publication
(10) Pub. No.: US 2017/0132484 A1
(43) Pub. Date: May 11, 2017

(54) Two Step Mathematical Expression Search

(71) Applicant: Christopher D. Malon, Fort Lee, NJ (US)

(72) Inventor: Christopher D. Malon, Fort Lee, NJ (US)

(21) Appl. No.: 14/933,149

(22) Filed: Nov. 5, 2015

(51) Int. Cl. G06K 9/20; G06F 17/30; G06K 9/34; G06K 9/00; G06K 9/18

(52) U.S. Cl. CPC G06K 9/2081; G06K 9/00463; G06K 9/18; G06K 9/344; G06K 9/348; G06F 17/30613

(57) ABSTRACT

Improvements to mathematical expression search functionality are made using an electronic document in ways unavailable with paper documents. A mathematical expression is exhibited within the document, and upon selection of a glyph within the mathematical expression, a display of different glyphs is made based on an expansion to the left, right, up, down, and/or diagonal of the selected glyph, each forming a different sub-expression. In this manner, a user can select one of the sub-expressions and load this sub-expression into memory to search the document or other documents for the selected sub-expression. The user also avoids having to enter complex mathematical symbols into a computer.

### FIELD OF THE DISCLOSED TECHNOLOGY

The disclosed technology pertains to a feature of electronic document viewers, enabling a user to graphically select and search for mathematical expressions.

### BACKGROUND OF THE DISCLOSED TECHNOLOGY

Complex mathematical notation and equations are traditionally and most naturally written by hand, not by computer, because of the variety of symbols used and their two-dimensional arrangements in mathematical expressions. Typing mathematical expressions can be laborious and requires the user to know which commands are used to produce which symbols. A standard notation for typing mathematics by computer was introduced by TeX (a software program first released in 1978 by Donald Knuth known by the mime type application/x-tex). Such software takes months or years to learn well, and graduate students continually refer to its reference manual as they encounter new typing needs.

Therefore, it is difficult to enter mathematics to be searched into a typical document viewer, such as a viewer for ISO 32000-1:2008 Portable Document Format (PDF). Many PDF readers have standard search features, but these are primarily useful for alphanumeric text. Depending on how a PDF document is encoded, a search for a Unicode character (if the user can find a way to type it on his keyboard) may or may not succeed. Even if a document viewer would support the entry of TeX notation in the search bar, the viewer would have to recognize many ways of typing a mathematical expression that have the same, or nearly the same, rendering.

Some previous search systems have enabled various forms of graphical or structural search. U.S. Pat. No. 8,160,939 to Schrenk discloses a graphical search system and method in which users enter search parameters by selecting images instead of typing text, allowing the selection of “sub-component” parts of each object. That is, an image becomes the search parameter.

U.S. Pat. No. 8,793,266 to Ishikawa et al. discloses a search query method that extracts text from a document, and allows the selection of search terms from the extractions. Their interface also allows terms to be joined with logical operators in a single search query.

U.S. Pat. No. 8,064,696 to Radakovic et al, discloses geometric parsing of mathematical expressions. A handwritten symbol or typeset mathematical expression can be recognized by repeatedly partitioning big sets of symbols into smaller ones. Single parts of a big graphic image are isolated as individual symbols for an optical character recognition (OCR) system to identify.

U.S. Patent Publication 2009/0019015 to Hijikata discloses a mathematical expression structured language object search system and search method. The search system and method apply to documents that are already given “a document tree structure of the mathematical expression structured language object.”

U.S. Pat. No. 7,181,068 to Suzuki et al. discloses a mathematical expression recognizing device and method.

Though these references show aspects of graphical or structural search or mathematical expression recognition, further progress is needed to allow one to select, input, or search for a mathematical expression more easily.

A reader who jumps to a theorem in the middle of a paper often needs to refer back to the preceding pages to understand the meanings of all the symbols used in the theorem. In the prior art, the reader usually would have to scan every printed or digital page without assistance from the computer. With prior technology, searches are typically performed by entering a sequence of characters (letters, numbers, and symbols) into a search box. In contrast to the sequential, one-dimensional nature of a text expression, mathematical expressions may use both horizontal and vertical dimensions to indicate superscripts (for example, to raise a quantity to an exponent) or subscripts (for example, to index a variable), among other usages. Therefore, to specify a mathematical expression, it is not enough to specify letters or symbols in sequence. Rather, the symbols and their two-dimensional arrangement must be specified.

### SUMMARY OF THE DISCLOSED TECHNOLOGY

A method of selecting a sub-expression in a mathematical expression in an embodiment of the disclosed technology involves exhibiting on a physical display a document having within it a mathematical expression made of a plurality of glyphs. Then a system or device receives output from a point-specific selection device indicating a selection of a point at or nearest to (and within an acceptable tolerance level of) at least one glyph of the plurality of glyphs within the mathematical expression. Then, using a hardware processor, the system identifies the aforementioned at least one glyph. Following instructions stored in the physical memory, or referring to an index retrieved from a storage device, the processor determines a plurality of sub-expressions within the mathematical expression that subsume the at least one glyph, and this is exhibited on the display.

The sub-expressions which subsume parts of the determined sub-expressions can be added to the determined sub-expressions and displayed as well. A step of receiving, via the point-specific selection device or another point-specific selection device, a selection of one of the plurality of sub-expressions displayed on the display or another display can be carried out. A step of searching, using the processor or another, for an additional occurrence of the one selected sub-expression and exhibiting the additional occurrence of the sub-expression with context on the display or other display can be carried out.

The search method matches occurrences of mathematical expressions by determining whether their constituent glyphs and the detected spatial relationships between adjacent glyph occurrences, including any horizontal, subscript, and superscript relations, are matching. Such constituent glyphs of the occurrences of mathematical expressions can be regarded as matching if their names are identical, even if other aspects of the glyphs are different. Or, two constituent glyphs can be regarded as matching if their glyph renderings are identical, or by way of testing whether optical character recognition produces the same output for bitmaps of the two glyphs in isolation. The detected spatial relations can be detected by testing inequalities in the coordinates of the bounding boxes of the glyph occurrences. The inequalities can differ depending on a name of the glyph as recorded in a font description or based on output of optical character recognition on the glyph.

Certain detected spatial relations may be marked as stopping points, which signify the end of a sub-expression. The criteria for marking a stopping point can be based on glyphs that are identified as punctuation, glyphs that are identified as delimiters (including at least one of parentheses or brackets), a size of a space between adjacent glyphs, a width comparison between adjacent glyphs, and/or superscript, subscript, or accent relations.

In another way of describing embodiments of the disclosed technology, a device with hardware processor reading instructions from physical memory to select and search a mathematical expression has a display exhibiting a first electronic document. It also has an input-receiving point-specific selection device indicating that a point on a page of the electronic document was selected. Upon said indication, a glyph closest to the selected point is determined. A module determining a set of occurrences of glyphs within a certain tolerance of the point is used as well as an expression module determining a set of mathematical expressions subsuming an occurrence of a glyph in the set of occurrences of glyphs. Mathematical expressions found based on the above steps are then exhibited on the display. A search module then receives a selection of a mathematical expression from the set of mathematical expressions by way of the point-specific selection device , and uses the hardware processor or another processor or cached results to find additional instances of the selected mathematical expression. The aforementioned additional instances can be in a second electronic document different from the first electronic document described above.

In another way of describing embodiments of the disclosed technology, a method of identifying mathematical expressions containing a given glyph occurrence is carried out based on the following steps. Glyphs and their locations are read in a document. The glyphs are then linked with each other according to geometric rules describing at least two of the following relationships: 1) nearby, horizontally adjacent glyphs, 2) subscripts, 3) superscripts, and 4) accents. A directed graph is determined on the glyphs and edges are labeled based on the afore-determined relationships. Each linking is marked as a possible stopping point or not according to at least two of the following rules: 1) punctuation, 2) delimiters, comprising parentheses and/or brackets, 3) a size of a space between adjacent glyphs compared to widths of each of said adjacent glyphs, and 4) subscript, superscript, or accent links. Based on this, one outputs an arrangement of glyphs having the glyph occurrence and all glyphs linked to it by repeatedly following links that are not possible stopping points. One also outputs one or more arrangements of glyphs within a connected component of the directed graph subsuming the arrangement, each arrangement having a property such that any two glyphs that are linked by repeatedly following links that are not possible stopping points are either both included in said arrangement or both excluded in said arrangement.

In an embodiment of the disclosed technology, each glyph is tagged with one or more classes, and the geometric rules for each type of glyph link are linear inequalities in coordinates of bounding boxes of the glyphs, depending on the classes of the glyphs to be related. An indexing method can be used to produce an index from arrangements of glyphs to occurrences of the arrangements on a document page. A second indexing method can be used in addition to the first method to produce an index from occurrences of glyphs on a document page to sets of arrangements of glyphs.

Embodiments described with reference to the device of the disclosed technology are equally applicable to methods of use thereof.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a,” and “b.”

### BRIEF DESCRIPTION OF THE DRAWINGS

FIG. 1 shows a high level selection of a sub-expression of a mathematical expression exhibited in an electronic document according to an embodiment of the disclosed technology.

FIG. 2 shows steps carried out to index a new document in embodiments of the disclosed technology.

FIG. 3 shows a high level flow chart of the steps taken to respond to a search query from a user in embodiments of the disclosed technology.

FIG. 4 shows an example of a mathematical expression and a spatial relation graph used in embodiments of the disclosed technology.

FIG. 5 shows a high-level block diagram of a device that may be used to carry out the disclosed technology.

### DETAILED DESCRIPTION OF EMBODIMENTS OF THE DISCLOSED TECHNOLOGY

Improvements to mathematical expression search functionality are made using an electronic document in ways unavailable with paper documents. A mathematical expression is exhibited within the document and, upon selection of a glyph within the mathematical expression, a display of different arrangements of glyphs is made based on an expansion to the left, right, up, down, and in diagonal directions from the selected glyph, each arrangement forming a different sub-expression. In this manner, a user can select one of the sub-expressions and load this sub-expression into memory to search the document or other documents for the selected sub-expression. The user also avoids having to enter complex mathematical symbols into a computer.

Embodiments of the disclosed technology will become clearer in view of the following description of the drawings.

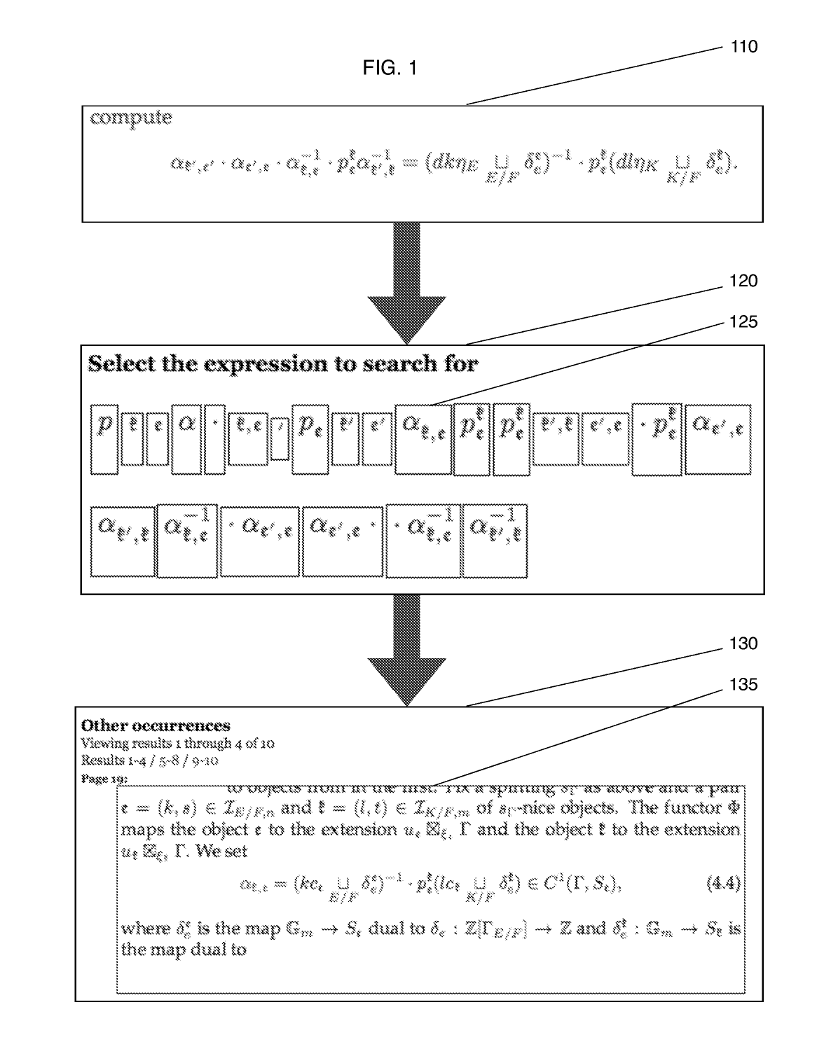

FIG. 1 shows a high level selection of a sub-expression of a mathematical expression exhibited in an electronic document. A sub-expression is defined as a mathematical expression in its own right within a larger mathematical expression. Such a sub-expression can be selected as follows. Block 110 shows an example mathematical expression. A user selects, with a point selection device such as a mouse, a point on, near, or closest to one of the symbols in the mathematical expression 110. Based upon the position of this point, the user is presented with a display of various sub-expressions 120. A user then points and selects one of the sub-expressions. This sub-expression is then loaded into memory and can be used to search this document or another document, based on search functions known in the art. In this example, the user selects sub-expression 125. The output of a search, which can be a search of the same document or another document, is shown in block 130.

If the user were to click on the third occurrence of the Greek letter alpha shown in 110, the list of arrangements of symbols displayed would include arrangements including the third alpha, as well as arrangements involving the second alpha, as well as arrangements involving some subscripts of either of those alphas, as shown in 120. Particularly, the arrangements include the third alpha by itself, the third alpha with its exponent and subscripts, and the two individual variables that occur in the subscript. Then, a user makes a selection using the point- specific input device to select one of the returned results. This input is received and processed by the processor to execute a search for the expression selected in the second search and exhibits/displays some context (defined as “characters, sentences, paragraphs, or breaks in the text”) around the search results. Each search result contains and/or comprises the arrangement of symbols that was selected. Block 130 shows a result returned in response to selecting sub-expression 125, in which alpha appears with its complete subscript of two variables, but without the “−1” exponent. Here, the sub-expression 125 is found within text block 135 shown for context. In this example, it is found on page 19 of the document. Search result 135 is useful because it provides a definition of sub-expression 125. If only a search that included the “−1” exponent were possible, a definition would not be found. If it were only possible to search for alpha without specifying the subscripts, this definition would be only one among many irrelevant usages of alpha.

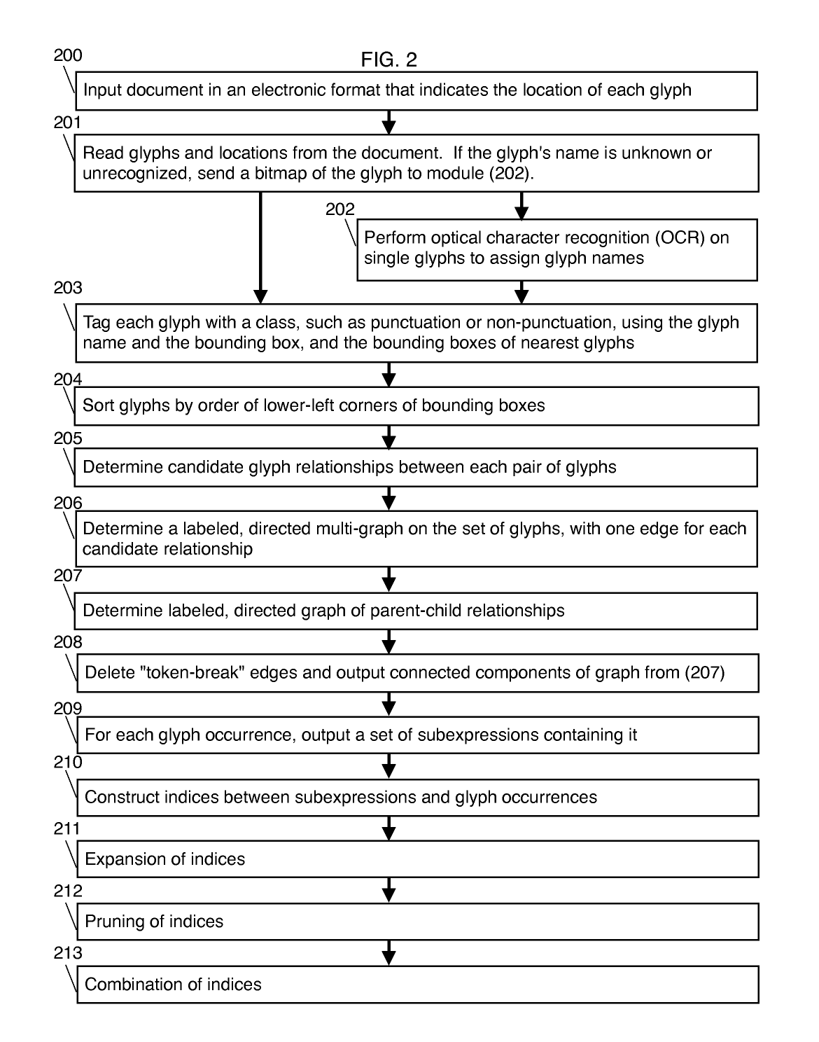

FIG. 2 shows a method of identifying mathematical expressions containing a given glyph occurrence as arrangements of glyphs, producing an index from arrangements of glyphs to occurrences of said arrangements on a document page, and producing an index from occurrences of glyphs on a document page to arrangements of glyphs The system receives a document as input in step 200 represented in an electronic format (including, but not limited to, Portable Document Format (PDF)) that indicates the location of glyph occurrences on each page of the document. For purposes of this disclosure, a “module” is a step carried out by, or is a device which uses , a hardware processor reading instructions stored in physical memory, the instructions being as described for each module. In the first reading module 201 (defined as a module which reads the text of the document) each of these glyphs is read. As defined in the PDF specification (ISO 32000-1:2008): “A character is an abstract symbol, whereas a glyph is a specific graphical rendering of a character. Glyphs are organized into fonts. A font defines glyphs for a particular character set. A font for use with a conforming reader is prepared in the form of a program. Such a font program is written in a special-purpose language, such as the Type 1, TrueType, or OpenType font format, that is understood by a specialized font interpreter. The font program contains glyph descriptions that generate glyphs. The glyph description consists of a sequence of graphic operators that produce the specific shape for that character in the font. To render a glyph, the conforming reader executes the glyph description.

A content stream paints glyphs on the page by specifying a font dictionary and string object that shall be interpreted as a sequence of one or more character codes identifying glyphs in the font.”

Based on the above terms from the PDF specification, we define some additional terminology. A glyph occurrence is defined as the instruction to render a glyph at a particular position on a particular page of a document. It consists of a glyph, a page number, and a bounding box on the page.

A glyph relationship is defined as an asymmetric relation R(x, y) that may be satisfied by an ordered pair of glyph occurrences x and y on the same page. If R(x, y) holds, then R(y, x) must not hold. In particular, R(x, x) never holds.

A same-line relationship is defined as a glyph relationship SL(x, y) that holds if x and y are horizontally adjacent and y is the character horizontally preceding x.

A glyph relationship filter is a computational procedure that computes whether an ordered pair of glyph occurrences would satisfy a glyph relationship. The result of the filter depends only on the pair of glyph occurrences, and not on any other glyphs present on the page.

A glyph relationship distance is a function assigning a real number to an ordered pair of bounding boxes. It need not be symmetric; for example, it could measure the Euclidean distance from the lower-left corner of the first bounding box to the lower-right corner of the second.

An arrangement of glyphs is a directed tree on a set of glyphs, in which each edge is labeled by a glyph relationship. Because it is a tree, it is connected, at most one edge can connect any pair of glyphs, and there is at most one outbound edge from any glyph.

An occurrence of an arrangement of glyphs is a one-to-one correspondence between the nodes of the arrangement of glyphs with a set of glyph occurrences, in which each glyph in the arrangement is the one rendered at the corresponding glyph occurrence, and the glyph relationships specified by the arrangement are satisfied by the corresponding glyph occurrences.

The reading module 201 reads the electronic document file, including the font programs and instructions to rendering string objects, which are sequences of one or more character codes identifying glyphs in the fonts, at particular positions on the page. Using the metrics provided in the font description and the starting position for the string, the module calculates a bounding box around each occurrence of each glyph in the document.

If the glyphs are not identified by name, a single-character optical character recognition (OCR) module 202 (defined as a module which converts bitmap data to symbol names) is utilized to provide names for individual glyphs by analyzing the bitmaps that are formed by executing their rendering instructions. OCR typically operates on bitmaps of scanned pages (with multiple glyphs and lots of noise). In isolation, one renders a single glyph and nothing else, and receives the output of an OCR engine to identify a glyph. In one embodiment of using module 202, glyphs are identified by unique strings assigned according to their bitmap rendering, so that they are declared equal to each other only if they have identical bitmaps (so that glyphs representing different font sizes of the same symbol might be regarded as different). In another embodiment, glyphs are recognized by symbol, regardless of having different font sizes or styles. Thus, one can match glyphs by comparing output of OCR on a specific glyph and a specific other glyph, even if the output does not identify a desired glyph name. When the output of the OCR engine on two different glyphs is equal, the glyphs may be regarded as matching. A set of glyph names and bounding boxes from either module 201 or 202 is output and provided to module 203.

Glyph classification module 203 tags each glyph with a class. A class is defined as having a differentiating feature of one glyph versus another. A first embodiment of module 203 assigns all glyphs to the same class. A second embodiment of module 203 determines punctuation, left delimiters (including but not limited to a left parenthesis, a left brace, and a left bracket), and right delimiters. To determine punctuation, it uses the glyph name (as “period” or “comma,” for example), or, if the glyph names are not sufficient, it looks for a characteristically shaped bounding box compared to the bounding box of its left neighbor or right neighbor. The characteristic shape is described by a set of linear inequalities in terms of the coordinates of the bounding boxes, scaled by the width of the left or the right character. Left and right delimiters include parentheses, braces, and brackets, and they are recognized by glyph names, or, if the glyph names are not sufficient, linear inequalities in terms of the coordinates of the bounding boxes, scaled by the width of the left or the right character, are tested. Order module 204 (defined as a module which determines an order to read glyph occurrences) sorts the glyph occurrences by the order of their lower-left vertices, first vertically, then horizontally (as a typewriter would move).

Relationship Module 205 (defined as a module determining which glyphs act on, effect, or require another glyph for a proper mathematical equation) applies a finite set of glyph relationship filters, including a same line relationship filter, to establish whether pairs of glyph occurrences satisfy the glyph relationships tested by said glyph relationship filters. A glyph relationship filter is given by a linear inequality in the coordinates of the bounding boxes of the two glyphs being related, scaled by the width of one of the glyphs. The inequalities to be tested may differ depending upon the output of module 203; for example, inequalities for glyphs tagged as punctuation may be adjusted so that a period is not mistaken as a superscript. In one embodiment, the possible glyph relationships are “same line,” “superscript,” “subscript,” and/or “accent.”

In module 206, for each pair of glyph occurrences satisfying a glyph relationship filter in 205, one directed edge is drawn between the glyph occurrences, labeled with the corresponding relationship. If multiple relationships between pairs of glyph occurrences are determined (for example, if the relationships for “same line” and “subscript” both are satisfied), then there may be multiple directed edges between the pair of glyph occurrences, and each is labeled with the corresponding relationship. Module 206 also applies a glyph relationship distance function for each relationship. In one embodiment, the taxicab distance between the bottom right of the left character and the lower left of the right character is used for “same line” glyph relationships, but the taxicab distance between the lower right of the left character and the upper left of the right character is used for “subscript” glyph relationships. Taxicab distance is a function that adds the sum of the absolute value of the difference in horizontal coordinates to the sum of the absolute value of the difference in vertical coordinates. Each edge is weighted by applying the glyph relationship distance function to the pair of glyph occurrences that are related. The weighted, directed multi-graph, labeled by edge relationships, is the output of module 206.

In 207, the directed multi-graph structure of 206 is used to assign each glyph occurrence to a parent, or leave it unassigned. The assignment is made by considering each glyph in the order established by module 204 as a potential child, considering its parents in the multi-graph of 206, if any. If any parents exist, the child is assigned to the parent with the edge of the lowest weight. Relationship labels are copied from the corresponding edges in the output of 206. The result of module 207 is a new directed graph, which is a subgraph of the output of 206. Note that in this subgraph, there is at most one directed edge between pairs of vertices, and every vertex may have several inbound edges, but only zero or one outbound edge.

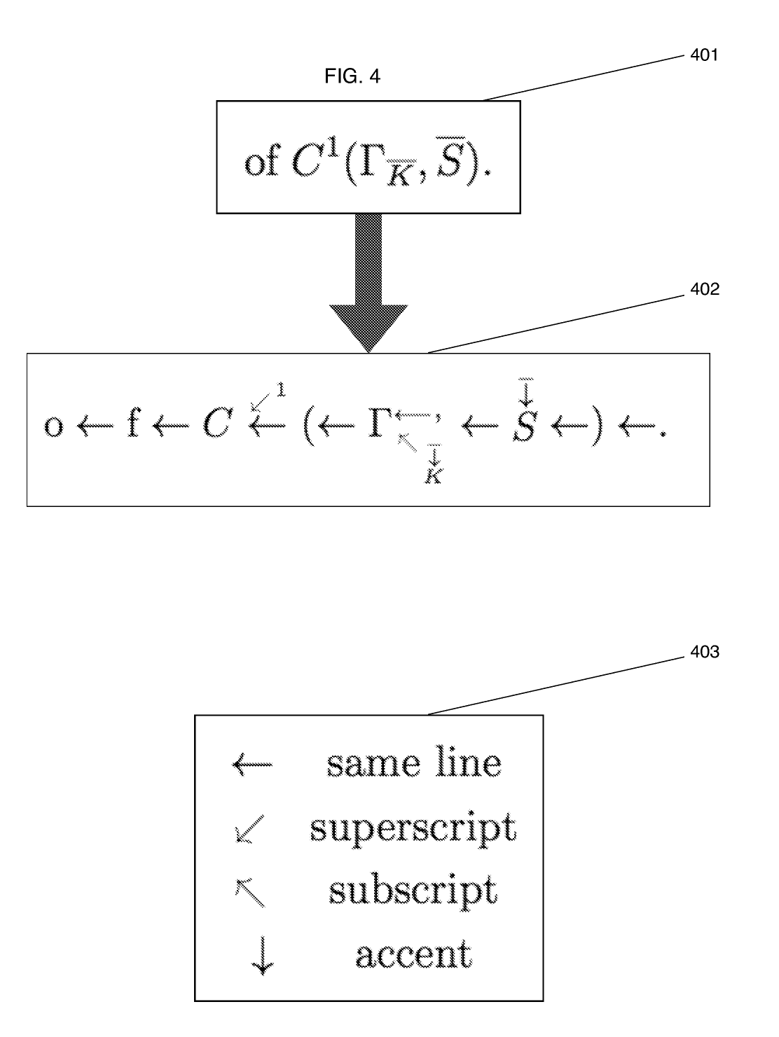

An illustration of the output of module 207 is given in FIG. 4. The original line of text 401 corresponds to an arrangement of glyphs shown as the directed graph 402. In the correspondence, each glyph occurrence in the original line of text corresponds to a vertex in the directed graph. Each of the edges in the directed graph corresponds to a detected glyph relationship. The edges are labeled with the type of glyph relationship detected. In the depiction of 402, these labels are indicated by the direction of the arrow, as shown in the legend 403.

The glyph classes established in 203, the order established in 204, and the graph output by 207 provide input to a lexer module 208 (a module performing lexical analysis). Call the nodes with no outbound edges “roots.” Each node of the graph has a “depth,” in which the depth of a root node is zero, and the depth of any other node is the number of edges that are not same-line relationships, along a minimal length path from the node to a root node. First, certain same-line relationships in the graph output by 207 are designated as “token breaks.” In one embodiment, the edges surrounding any glyph tagged as punctuation by module 203 are token breaks, the edges surrounding any glyph tagged as a left delimiter or right delimiter (including, but not limited to, parentheses and brackets) by module 203 are token breaks, and any other same-line relationship in which the glyph relationship distance surpasses a threshold size compared to the widths of the related glyphs (in other words, a large space) is also a token break. Module 208 deletes edges corresponding to “token breaks” when the source and the target of the edge have zero depth. After edges corresponding to token breaks are deleted, a sequence of tree subgraphs of 207 is established, consisting of all the connected components. These connected components are trees, having a unique “root” node without outbound edges (which may not have been a root before edge deletion). The sequence is ordered by the sequence of the root nodes within the output of 204, and each glyph occurrence is represented by a node in exactly one of the subgraphs. This sequence, and the list of undeleted token breaks, is the output of the lexer module 208.

The results of the lexer module 208 are used by an “arrangement module” 209, which determines various arrangements of glyphs that include a given glyph occurrence. In a document in the scientific literature, these arrangements may consist of words, or of various parts (“expressions”) within a mathematical formula. At each glyph occurrence, we consider the corresponding node of a subgraph in the sequence output by 208. Module 209 determines certain subgraphs that contain this node. We define the “minimal expression” of a glyph to be the set or set of nodes connected to the glyph by “same-line” relationships that are not token breaks. In one embodiment, the module outputs the set of subtrees containing the original glyph with the property that, if a node is contained in the subtree, then its entire minimal expression is contained in the subtree. Equivalently, all glyph relationships detected are followed from the original glyph, until possibly stopping at relationships that are token breaks, or else not same-line relationships (i.e., they may be subscript relationships, superscript relationships, accent relationships, or any of the other glyph relationships, except same-line, detected in module 207). Another embodiment uses the glyph classes output by 203 to output smaller sets of subgraphs, by stopping at punctuation marks and by stopping where left delimiters (such as a left parenthesis “(”) would be out of balance with right delimiters (such as a right parenthesis “)”).

An indexing module 210 takes the arrangements output by 209, and outputs a “forward index” listing, for each arrangement of glyphs, the set of occurrences of the arrangement within the document, and a “backward index” listing, for each occurrence of glyphs on pages of the document, the sets of arrangements containing that glyph as computed by module 209.

An expansion module 211 is defined as one which takes the indices output by 210, and adjusts them to replace the forward and backward indices. In one embodiment, the expansion module does nothing. In another embodiment, the expansion module adds new items to the forward and backward indices when an arrangement occurs in the index frequently, by linking arrangements across token boundaries. For example, if the variable “y” appears in the document ten times, it could index “y” together with the previous or next token in the sequence of 208. Thus “x+y” may be added to the forward and backward indices, even if token breaks between “x”, “+”, and “y” would prevent “x+y” from being indexed in 209. The module 211 may use information output by the glyph class module 203.

A pruning module 212 is defined as one which takes the indices output by 211 and adjusts them to replace the forward and backward indices. The pruning module is used in only some embodiments of the disclosed technology. In one embodiment, the pruning module removes arrangements from the forward and backward indices if they occur only once. In some embodiments, the pruning removes arrangements that occur too frequently (for example, words such as “the”). In one embodiment, module 212 also removes isolated punctuation and delimiters, as identified by the output by the glyph class module 203, from the indices. The output of module 212 completes the indexing process of a single document.

A combination module 213 (defined as a module which takes the forward index from a single document and merges it with forward indices found on other documents), may be added to an embodiment, to provide cross-document search facilities.

The system also contains a method for selecting a sub-expression within a mathematical expression displayed in an electronic document, and for searching for an additional occurrence of the selected sub-expression. The user interacts with the system through a graphical user interface, including, but not limited to, a computer with a mouse, a tablet with a stylus, or a smartphone with a touch screen. The computers that perform the indexing, that implement the user interface, and that respond to search queries, may be separate entities in a computer network, and the indexing of a document may be completed at any time before responding to a user query (perhaps in response to a previous user, or in response to being loaded from an external source).

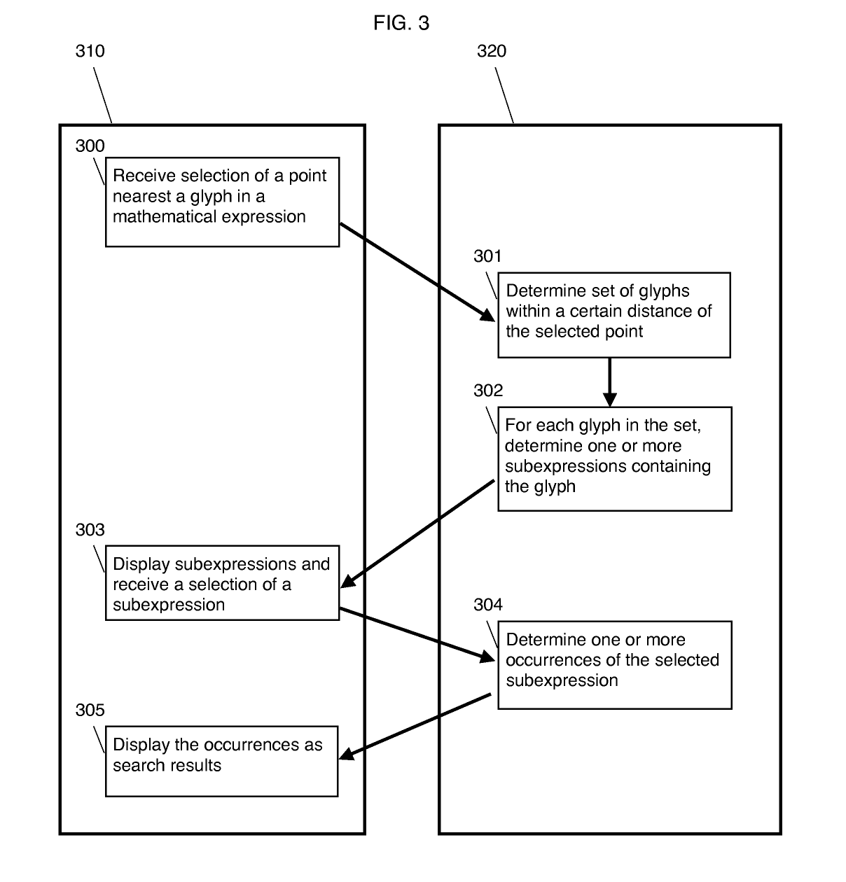

FIG. 3 shows a high level flow chart of the steps taken to carry out embodiments of the disclosed selection and search method. The steps in box 310 are executed on a graphical user interface, and the steps in box 320 are executed by the search query handler, which may be implemented by instructions on the same processor as the graphical user interface or, without limitation, on a processor connected across a network interface. A document with mathematical expression comprising a plurality of glyphs is exhibited on a display. In step 300, output from a point-specific selection device is received, indicating a selection of a point at or nearest to and within an acceptable tolerance level of at least one glyph within the mathematical expression. In step 301, using a hardware processor, the set of glyphs within a certain distance of the selected point is determined. For each glyph, if any, that lies within the certain distance, in step 302, sub-expressions containing the glyph are retrieved from a backward index, such as an index prepared according to FIG. 2. In step 303, an occurrence of each of the sub-expressions is displayed, and a selection of one of the displayed sub-expressions is then received using a point-specific selection device. Then, in step 304, the forward index is used to determine other places in the document, or other documents, where the sub-expression is found. In step 305, if said other places are found, one or more of said other places is exhibited on a physical display, including some context, as illustrated in FIG. 1.

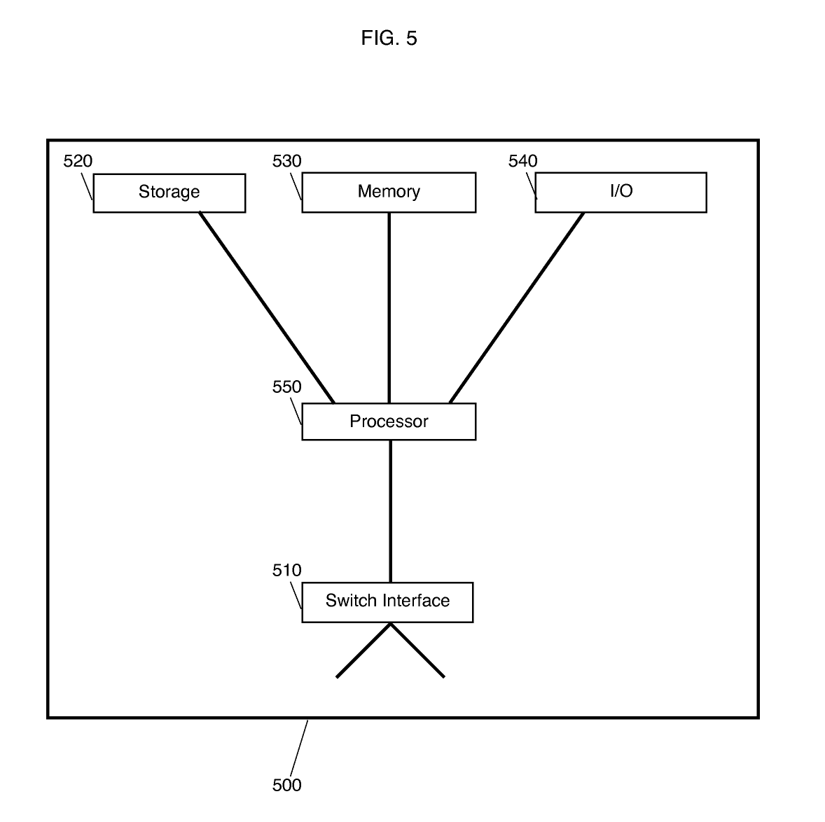

FIG. 5 shows a high-level block diagram of a device that may be used to carry out the disclosed technology. Device 500 comprises a processor 550 that controls the overall operation of the computer by executing the device's program instructions which define such operation. The device's program instructions may be stored in a storage device 520 (e.g., magnetic disk, database) and loaded into memory 530 when execution of the program instructions is desired. Thus, the device's operation will be defined by the device's program instructions stored in memory 530 and/or storage 520, and the console will be controlled by processor 550 executing the console's program instructions. A device 500 also includes one, or a plurality of, input network interfaces for communicating with other devices via a network (e.g., the Internet). The device 500 further includes an electrical input interface. A device 500 also includes one or more output network interfaces 510 for communicating with other devices. Device 500 also includes input/output 540 representing devices which allow for user interaction with a computer (e.g., display, keyboard, mouse, speakers, buttons, etc.), including a point-specific selection device (comprising a mouse or touchpad or cursor keys on a keyboard). One skilled in the art will recognize that an implementation of an actual device will contain other components as well, and that FIG. 5 is a high level representation of some of the components of such a device for illustrative purposes. It should also be understood by one skilled in the art that the method and devices depicted in FIGS. 1 through 4 may be implemented on one or more devices such as the one shown in FIG. 5.

The present invention can overcome errors in glyph identification. If the class output by module 203 does not change, mis-recognizing the glyph name does not affect search results, as long as the same mis-recognitions are made consistently throughout a document. On the other hand, the present invention may read symbols it has never encountered before, and accurately match them across the document, unlike a recognition system, which would try to match every glyph to some universal set of known symbols.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein are also contemplated and within the scope of the invention.

I claim:

1. A method of selecting a sub-expression in a mathematical expression comprising the steps of:
exhibiting on a physical display a document with mathematical expression comprising a plurality of glyphs;
receiving output from a point-specific selection device indicating a selection of a point at or nearest to, and within an acceptable tolerance level of, at least one glyph of said plurality of glyphs within said mathematical expression;
using a hardware processor, carrying out instructions stored in physical memory to identify said at least one glyph;
using said or another hardware processor, carrying out instructions stored in said physical memory or retrieved from a storage device holding data representative of a previously prepared index, determining a plurality of sub-expressions within said mathematical expression subsuming said at least one glyph;
exhibiting said plurality of sub-expressions within said mathematical expression on said display or another display.

2. The method of claim 1, wherein the method adds to said plurality of sub-expressions sub-expressions that subsume parts of other said sub-expressions.

3. The method of claim 1, further comprising a step of receiving, via said point-specific selection device or another point-specific selection device, a selection of one of said plurality of sub-expressions displayed on said display or another display.

4. The method of claim 3, further comprising a step of searching, using said processor or said other processor, for an additional occurrence of said one selected said sub-expression and exhibiting said additional occurrence of said sub-expression with context on said display or said other display.

5. The method of claim 4, wherein the search method matches occurrences of mathematical expressions by determining whether their constituent glyphs and the detected spatial relationships between adjacent glyph occurrences, including any horizontal, subscript, and superscript relations, are matching.

6. The method of claim 5, wherein said constituent glyphs of said occurrences of mathematical expressions are regarded as matching if their names are identical.

7. The method of claim 5, wherein said constituent glyphs of said occurrences of mathematical expressions are regarded as matching when the renderings of the glyphs are identical.

8. The method of claim 5, wherein said constituent glyphs of said occurrences of mathematical expressions are regarded as matching by testing whether an optical character recognition module produces the same output for bitmaps of the two said glyphs in isolation.

9. The method of claim 5, wherein said detected spatial relations are detected by testing inequalities in the coordinates of the bounding boxes of said glyph occurrences.

10. The method of claim 9, wherein said inequalities to be tested differ depending on a name of said glyph as recorded in a font description or on the output of an optical character recognition module.

11. The method of claim 5, wherein said set of mathematical expressions subsuming an occurrence of a glyph is formed by following detected spatial relations from the original said occurrence of said glyph to add glyphs to the expression, following more or fewer glyphs before stopping.

12. The method of claim 11, wherein said stopping is as a result of one of the following: punctuation;
delimiters, including at least one of parentheses or brackets;
a size of a space between adjacent glyphs, compared to a width of said adjacent glyphs;
superscript, subscript, or accent relations.

13. A device with hardware processor reading instructions from physical memory to select and search a mathematical expression, comprising:
a display exhibiting a first electronic document;
an input-receiving datum from a point-specific selection device indicating that a point on a page of said electronic document was selected, wherein said hardware processor determines a glyph closest to said selected point;
a module determining a set of occurrences of glyphs within a certain tolerance of said point;
an expression module determining a set of mathematical expressions subsuming an occurrence of a glyph in said set of occurrences of glyphs, and outputting said mathematical expressions to said display;
a search module receiving a selection of a mathematical expression from said set of mathematical expressions by way of said point-specific selection device which uses said hardware processor or another processor or cached results to find additional instances of the selected mathematical expression.

14. The device of claim 13, wherein said additional instances are in a second electronic document different from said first electronic document.

15. A method of identifying mathematical expressions containing a given glyph occurrence, comprising:
reading glyphs and their locations from the document;
linking glyphs according to geometric rules describing at least two of the following relationships:
nearby, horizontally adjacent glyphs,
subscripts,
superscripts, and
accents,
whereby a directed graph is determined on the glyphs and wherein edges are labeled by said relationships;
marking each said linking as a possible stopping point or not according to at least two of the following rules:
punctuation,
delimiters, comprising parentheses and/or brackets,
a size of a space between adjacent glyphs compared to widths of each of said adjacent glyphs , and
subscript, superscript, or accent links;
outputting:
an arrangement of glyphs consisting of said glyph occurrence, and all glyphs linked to it by repeatedly following links that are not possible stopping points,
one or more arrangements of glyphs within a connected component of said directed graph subsuming said arrangement, each arrangement having a property such that any two glyphs that are linked by repeatedly following links that are not possible stopping points are either both included in said arrangement or both excluded in said arrangement.

16. The method of claim 15, wherein each glyph is tagged with one or more classes, and said geometric rules are linear inequalities in coordinates of bounding boxes of said glyphs, depending on said classes of the glyphs to be related.

17. The method of claim 15, further comprising an indexing method to produce an index from arrangements of glyphs to occurrences of said arrangements on a document page.

18. The method of claim 17, further comprising a second indexing method to produce an index from occurrences of glyphs on a document page to sets of arrangements of glyphs.
